(19) United States
(12) Patent Application Publication
(10) Pub. No.: US 2004/0079606 A1
(43) Pub. Date: Apr. 29, 2004

(54) Double clutch assembly

(75) Inventors: Andreas Orlamunder, Schweinfurt (DE); Sebastian Vogt, Bad Neustadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/628,062

(22) Filed: Jul. 25, 2003

(30) Foreign Application Priority Data
Jul. 25, 2002 (DE) 102 33 791.8
Nov. 22, 2002 (DE) 102 54 903.6

(51) Int. Cl. F16D 21/02

(52) U.S. Cl. 192/48.8

(57) ABSTRACT

A double clutch assembly includes a first clutch area with a first pressure plate, which can be moved by a first force-exerting assembly toward an abutment assembly; a second clutch area with a second pressure plate, which can be moved by a second force-exerting assembly toward an abutment assembly; and a connecting assembly for connecting the abutment assembly to a drive element. The connecting assembly includes a connecting plate assembly with a first, radially outer connecting section, which extends over an outer circumferential surface of the abutment assembly and is attached thereto by a plurality of connecting elements.

### BACKGROUND OF THE INVENTION

1. Field of the Invention

The present invention relates to a double clutch assembly that includes a first clutch area with a first pressure plate, which can be moved by a first force-exerting assembly toward an abutment assembly; a second clutch area with a second pressure plate, which can be moved by a second force-exerting assembly toward the abutment assembly; and a connecting assembly for connecting the abutment assembly to a drive element.

2. Description of the Related Art

In these types of double clutch assemblies, the area which is to be connected by the connecting assembly to a drive element, such as the crankshaft of an internal combustion engine, is usually not at an axial end of the clutch assembly, as is the case in conventional single clutches; on the contrary, it is located in a central area between the two clutch areas. This makes it difficult to connect the double clutch assembly using the connecting assembly, especially because this connection is usually made in an area which is at least partially covered by a transmission shroud or clutch shroud.

### SUMMARY OF THE INVENTION

The object of the present invention is to provide a double clutch assembly wherein the connection to the drive element can be easily made and unmade, but also so that the connection is reliable.

According to a first aspect of the present invention, the connecting assembly includes a connecting plate with a radially outer first connecting section extending over an outer circumferential surface of the abutment assembly and is attached thereto by a plurality of connecting elements.

Because the connecting plate assembly extends over the radially outside area of the abutment assembly, it is easy to gain access radially from the outside to the various connecting elements so that they can be fastened or removed.

To simplify the overall design of an assembly of this type even more, it is proposed that the first connecting section be provided in an area of the connecting plate assembly which extends approximately in the axial direction, this first section following axially after a starter gear ring formed as an integral part of the connecting plate assembly.

According to another aspect of the present invention, the double clutch assembly includes an axial projection formation on the abutment assembly, which extends radially, preferably radially on the outside, over at least part of the first connecting section of the connecting plate assembly; and a plurality of connecting elements for the torsion-proof connection of the first connecting section to the axial projection formation.

In addition to the advantage that access for making or unmaking the connection is obtained radially from the outside in this embodiment also, a reliable centering of the abutment assembly and thus also of the two clutch areas with respect to the connecting plate assembly and thus also with respect to the drive element is also realized here.

The connecting elements can be, for example, screw bolts, riveting bolts, or the like.

According to another aspect of the present invention, the double clutch assembly includes an intermediate connecting ring, fastened by a first group of connecting elements to a radially outer area of the abutment assembly, and a connecting plate with a radially outer first connecting section is fastened to the intermediate connecting ring by a second group of connecting elements.

In this embodiment, therefore, the connection is established by an intermediate connecting ring, so that, through the use of this intermediate connecting ring, axial gaps, for example, can be spanned.

Here, too, an integration of functions can be realized in the area of the intermediate connecting ring, in that the starter gear ring is formed on the intermediate connecting ring.

So that the overall assembly is very sturdy as well as very simple, it is proposed that at least some of the connecting elements of the first group of connecting elements and at least some of the connecting elements of the second group of connecting elements be designed as screw bolts, and that internally threaded holes be provided in the intermediate connecting ring, each one of which can accept one of the connecting elements of the first group of connecting elements designed as screw bolts and one of the connecting elements of the second group of connecting elements designed as screw bolts. For cost reasons, the intermediate connecting plate can be a formed metal plate, but especially when it is intended to serve simultaneously as a starter gear ring it can be a metal part produced by a casting process or by a metal-cutting process.

To prevent the intermediate connecting ring from interfering with the first connecting section, especially when the intermediate connecting ring is designed as a gear ring, it is proposed that the first connecting section be designed to extend essentially in the radial direction.

According to another aspect of the present invention, the connecting assembly includes a connecting plate assembly with a first, radially outer, essentially radially oriented connecting section, which is connected by a plurality of connecting elements to a radially outer area of the abutment assembly for rotation in common.

It can be provided here that at least some of the connecting elements have a tapering attachment section, each of which is inserted into a correspondingly tapering attachment hole in the abutment assembly. When it is also provided that at least some of the connecting elements have a tapering section which passes through the first connecting section, then it is ensured simultaneously that the first connecting section is tightly connected axially to the abutment assembly. As an alternative, it is also possible for at least some of the connecting elements to have a cylindrical section which passes through the first connecting section. This design makes it possible for the connecting elements to be held firmly in place on the abutment assembly, and then the abutment assembly can be moved axially toward the connecting plate assembly, so that the connecting elements can be pushed into the holes provided for them in the first connecting section.

According to another aspect of the present invention, the connecting assembly includes a connecting plate assembly with a radially outer first connecting section which has a set of gear teeth, which engages with an opposing set of gear teeth on the abutment assembly for rotation in common.

Because of the two sets of gear teeth which engage with each other, there is no need for any additional connecting elements, which means that a connection can be achieved simply by moving the two assemblies axially toward each other.

To avoid chattering noises in the area of the gear teeth when rotational irregularities are present, it is proposed that the set of gear teeth and the opposing set of gear teeth be pretensioned into a state of mutual engagement. It an also be helpful here for the teeth of the first set to taper down toward their free ends and for these free ends to engage in correspondingly tapered gaps in the opposing set of teeth.

In the double clutch assembly according to the invention, the double clutch assembly can be connected to the drive element in a manner which at least partially suppresses wobbling movements by the use of a connecting plate assembly including a radially outer connecting plate part having the first connecting section, a radially inner connecting plate part having a second connecting section, which can be connected to the drive element, and an elastic connecting assembly connecting the radially outer connecting plate part to the radially inner connecting plate part in a manner which allows relative movement between them.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a partial longitudinal cross-sectional view through a double clutch assembly according to the invention;

FIG. 2 is a cross-sectional view of a gear ring in the form of a separate formed metal plate;

FIG. 3 is a cross-sectional view, corresponding to FIG. 1, of an alternative embodiment;

FIG. 4 is a cross-sectional view in detail of a modification of the double clutch assembly illustrated in FIG. 3;

FIG. 5 is another cross-sectional view in detail of a modification of the double clutch assembly illustrated in FIG. 3;

FIG. 6 is a partial longitudinal cross-sectional view, corresponding to FIG. 1, of an alternative embodiment;

FIG. 7 is a partial longitudinal cross-sectional view, corresponding to FIG. 1, of an alternative embodiment;

FIG. 8 is a partial longitudinal cross-sectional view, corresponding to FIG. 1, of an alternative embodiment;

FIG. 9 is a cross-sectional view in detail of a modification of the embodiment illustrated in FIG. 8;

FIG. 10 is a partial longitudinal cross-sectional view corresponding to FIG. 1, of an alternative embodiment,

FIG. 11 is a cross-sectional view in detail of a modification of the embodiment illustrated in FIG. 10;

FIG. 12 is a cross-sectional view of one embodiment for avoiding chattering noises in mutually engaging sets of gear teeth;

FIG. 13 is a cross-sectional view of the assembly of FIG. 12 in the assembled state; and

FIG. 14 is a partial longitudinal cross-sectional view of an alternative embodiment of a double clutch assembly.

### DETAILED DESCRIPTION OF THE PRESENTLY PREFERRED EMBODIMENTS

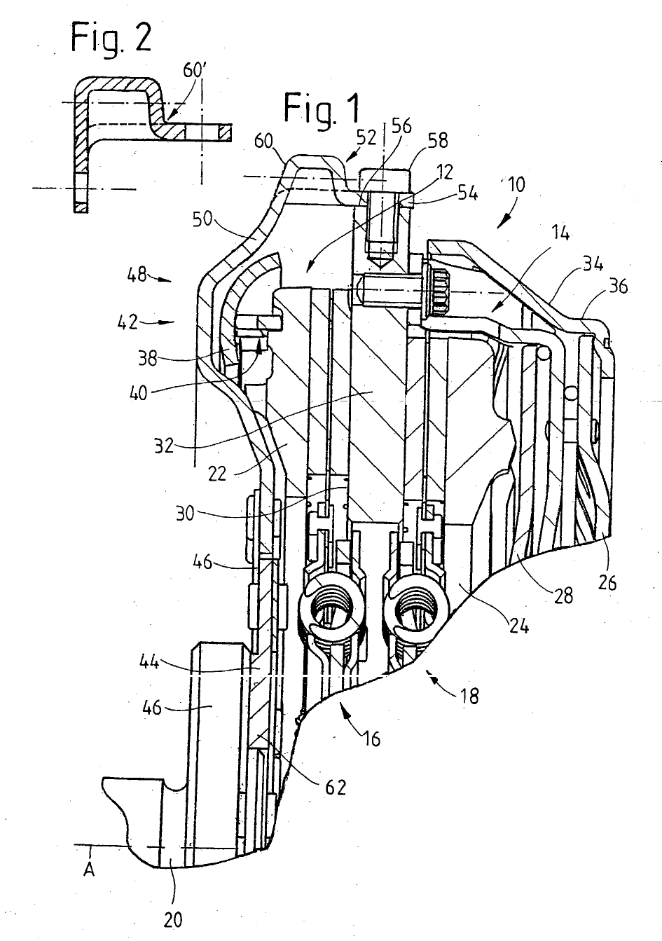

FIG. 1 shows a double clutch assembly 10 including two clutch areas 12, 14, by which either one of two transmission input shafts, i.e., either one of the two clutch disks 16 or 18 nonrotatably connected to these input shafts, can be nonrotatably connected as desired to a drive element 20, such as the crankshaft of an internal combustion engine.

Each of the two clutch areas 12, 14 comprises a pressure plate 22, 24. Each of these pressure plates can be pretensioned by the force exerted by a force-exerting assembly 26, 28 toward an intermediate plate 32, which provides an abutment assembly 30 for the two clutch areas 12, 14, so that, as a result, the clutch disks 16, 18 assigned to the clutch areas 12, 14 in question, can be clamped between the pressure plates 22, 24 and the intermediate plate 32 for the transmission of torque.

The force-exerting assemblies 26, 28 can be designed as, for example, lever assemblies, by means of which an engaging force, provided by an actuating mechanism, can be transmitted to the various pressure plates 22, 24. It is also possible, however, to use force-storing devices such as diaphragm springs as the force-exerting assemblies, which themselves provide the engaging force and which are acted upon by an actuating mechanism to implement clutch-release operations. The force-exerting assembly 28 of the second clutch area 14 is supported in the radially outer area on a housing part 34, which is firmly connected to the intermediate plate 32, whereas an area further inward in the radial direction acts on the pressure plate 24. The radially outer part of the force-exerting assembly 26 of the first clutch area 12 acts on a force-transmitting element 36, whereas an area further inward in the radial direction is supported on the housing part 34. Its radially innermost area (not shown) is acted upon by an appropriate mechanism for implementing actuating operations. The force-transmitting element 36 transmits the clutch-engaging force via elements (not shown) such as tie-rods to another ring-like force-transmitting element 38, which then acts via, for example, a wear take-up device 40 on the pressure plate 22 of the first clutch area 12.

Insofar as the design of the various clutch areas 12, 14 of the double clutch assembly 10, described only very generally above, is concerned, it is obvious that a wide variety of variations can be provided, especially with respect to the way in which force is transmitted to the pressure plates, the way in which the wear take-up devices are provided, the design of the clutch disks, and the design of the pressure plates 22, 24. It is important, however, to provide the intermediate plate 32, which, with respect to the axis of rotation A, is located essentially between the two clutch areas 12, 14 and therefore forms the interface between these two clutch areas 12, 14. As will be described in detail below, this intermediate plate 32 can be connected to the drive element 20 so that torque can be transmitted from the drive element 20 to the intermediate plate 32 and from this intermediate plate to the clutch areas 12, 14.

In the case of the embodiment shown in FIG. 1, a connecting assembly 42 is provided, which makes it possible for the intermediate plate 32 to be connected to the drive element 20. This connecting assembly 42 includes a radially inner connecting plate part 44, which can be connected nonrotatably by screws, bolts, by serrations, or the like to a shaft flange 19 of the drive element 20. Several leaf spring elements 46 or other elastic connecting elements connect the radially outer connecting plate part 50 to the radially inner connecting plate part 44. Thus, the outer part works together with the radially inner connecting plate part 44 to form a connecting plate assembly 48. The radially outer part 50, like the radially inner connecting plate part 44, can consist of a formed metal plate. The radially outer connecting plate part 50 has a more-or-less axially oriented section 52 radially on the outside. At one axial end, this section 52 forms a first connecting section 54 of the connecting plate assembly 48; this section extends over the outer circumferential surface 56 of the ring-shaped, disk-like intermediate plate 32. The connecting plate assembly 48 is firmly connected in the area of this first connecting section 54 to the intermediate plate 32 by means of bolts 58 distributed around the circumference. Axially adjacent to this first connecting section 54, a gear ring 60 is formed on the radially outer connecting plate part 50. Thus, this connecting plate part 50, with its essentially axially oriented radially outer area 52, provides two elementary assemblies, namely, the first connecting section 54 and the gear ring 60. The gear ring can be produced during the process of shaping the first connecting plate part 50 by means of rolling, that is, by plastic deformation.

The embodiment of the double clutch assembly 10, i.e., of the connecting assembly 42 of such a clutch assembly, shown in FIG. 1, makes it easy to establish the desired connection. In this embodiment, several of the bolts 58 can be accessed simultaneously in the radial direction from the outside. Because of the additional presence of the elastic leaf spring elements 46, it becomes possible simultaneously to decouple the movement of the first connecting section 54 from that of the second connecting section 62, by which the connecting assembly 42 is connected to the drive element 20, which means that the transmission and/or occurrence of wobbling movements in the area of the two clutch areas 12, 14 can be avoided. This elasticity can also be realized by connecting the two connecting plate parts 44, 50 integrally to each other by the use of connecting web sections with elastic properties, which webs are formed by stamping the sheet metal blank in an appropriate manner.

FIG. 2 shows a gear ring 60′, designed here as a separate component, i.e., not produced as an integral part of the radially outer connecting plate part 50, but rather connected to it by rivets, or the like.

FIGS. 3-5 show an alternative design of a double clutch assembly according to the invention, wherein the components which correspond to those previously described with respect to their design or function are designated by the same reference numbers plus an “a”.

In the case of the embodiment shown in FIG. 3, an axial projection formation 70a, possibly designed as a ring encircling the axis of rotation A, is formed in an radially outer area of the intermediate plate 32a and projects from one of the axial sides of this plate, namely, from the side to be positioned facing the drive element 20a. The radially outer connecting plate part 50a again has the essentially axially oriented area 52a in its radially outer area; this axial area 52a provides the first connecting section 54a. In the area of this approximately cylindrical first connecting section 54a, the connecting plate part 50a is introduced axially into the projection formation 70a, so that the first connecting section 54a rests against a radially inward-facing surface or inner circumferential surface of the projection formation 70a. Several connecting elements, designed here as stud screws 72a, are screwed into the projection formation 70a; these screws 72a extend radially inward to engage in associated holes in the first connecting section 54a. Thus the connecting plate assembly 48a and the intermediate plate 32a are held together both axially and circumferentially. In this embodiment, furthermore, it is also provided that the starter gear ring 60a is formed as an integral part of the radially outer area of the intermediate plate 32a.

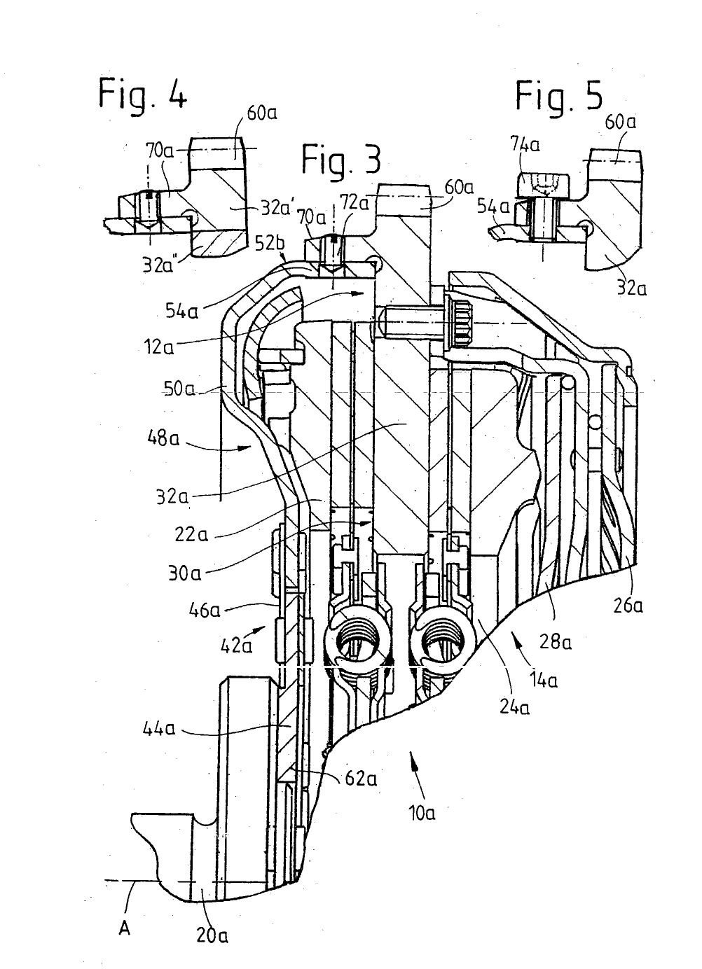

FIG. 4 shows an embodiment in which the intermediate plate 32a is divided in the radially outer area. The starter gear ring 60a is now formed on an outer intermediate plate part 32a′, which is shrunk-fit, for example, onto an inner intermediate plate part 32a″. The axial projection-formation 70a is formed on the outer intermediate plate part 32a′.

In the embodiment shown in FIG. 5, normal screw bolts 74a are provided as connecting elements. These can have, for example, a hexagonal recess to allow the insertion of an Allen wrench.

As also in the case of the embodiment shown in FIG. 1, the embodiment and its variations shown in FIGS. 3-5 offer the advantage that the intermediate plate 32a is centered with respect to the connecting assembly 42a and thus also with respect to the drive element 20a. In addition, it is advantageous here that, under the effect of centrifugal force, the connecting plate part 50a, which is usually made in the form of a formed metal plate, will rest in the radially outward direction with greater force against the projection formation 70a, as a result of which an even better connecting effect is made possible.

In the embodiment shown in FIG. 3, it is obvious that both the connecting section 54a and the projection formation 70a can be interrupted in the circumferential direction; that is, they can include several axially projecting sections.

Of course, it is also possible to adapt the projection formation 70a and the connecting section 54a to each other in such a way that the connecting section 54a extends radially beyond the projection formation 70a and rests against it radially from the outside.

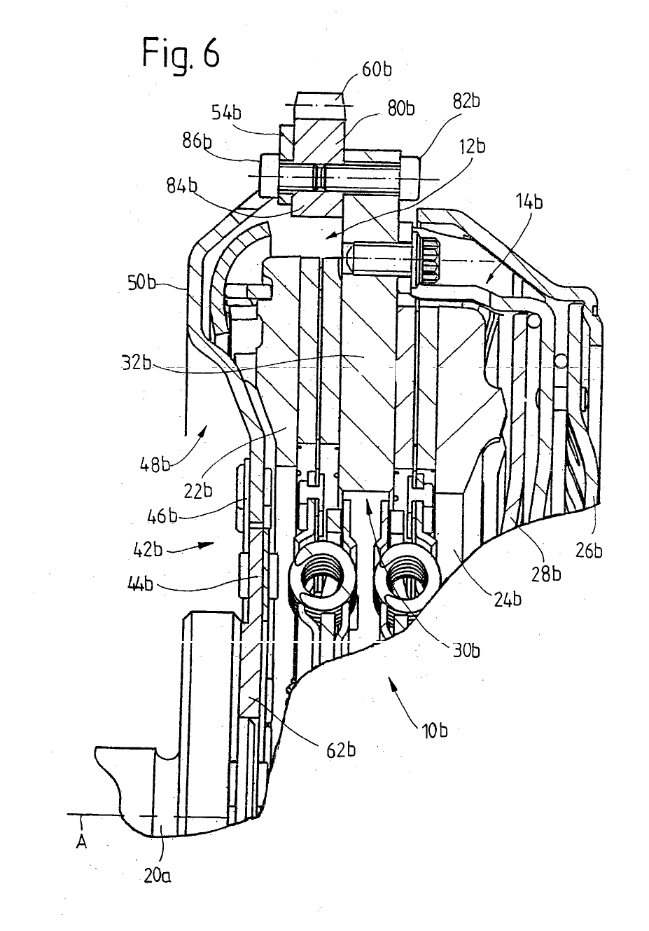

Another double clutch assembly designed in accordance with the invention is shown in FIG. 6. Components which correspond to those described previously with respect to design or function are designated by the same reference numbers plus a “b”.

In the embodiment shown in FIG. 6, an intermediate connecting ring 80b is provided, which simultaneously has or forms the starter gear ring 60b. Several bolts 82b are passed through or are screwed into the radially outer area of the intermediate plate 32b and then screwed into internally threaded holes 84b assigned to them in the intermediate connecting ring 80b. The first connecting section 54b of the connecting plate part 50b is now provided as an essentially radially-oriented area and also has pass-through openings, through which screw bolts 86b are passed and are also screwed into the internally threaded holes 84b. Thus, at least some of the internally threaded holes 84b accept both a bolt 82b and a bolt 86b.

This embodiment not only makes it possible to connect the intermediate plate 32b easily to the connecting assembly 42b, but also provides an easy-to-produce design, because both the intermediate plate 32b and the intermediate connecting ring 80b providing the gear ring 60b can be designed as flat components with essentially no axial projections.

In this embodiment, the bolts 82b, 86b, each of which is screwed into an internally threaded hole 84b, can obviously be replaced by riveting bolts, which are inserted through the intermediate plate 32b, through the intermediate connecting ring 80b, and through the first connecting section 54b. In this case, the holes provided in the intermediate connecting ring 80b do not have to be provided with internal threads. It is also possible, of course, for at least some of the internally threaded holes provided for the bolts 82b, 86b to be offset with respect to each other in the circumferential direction.

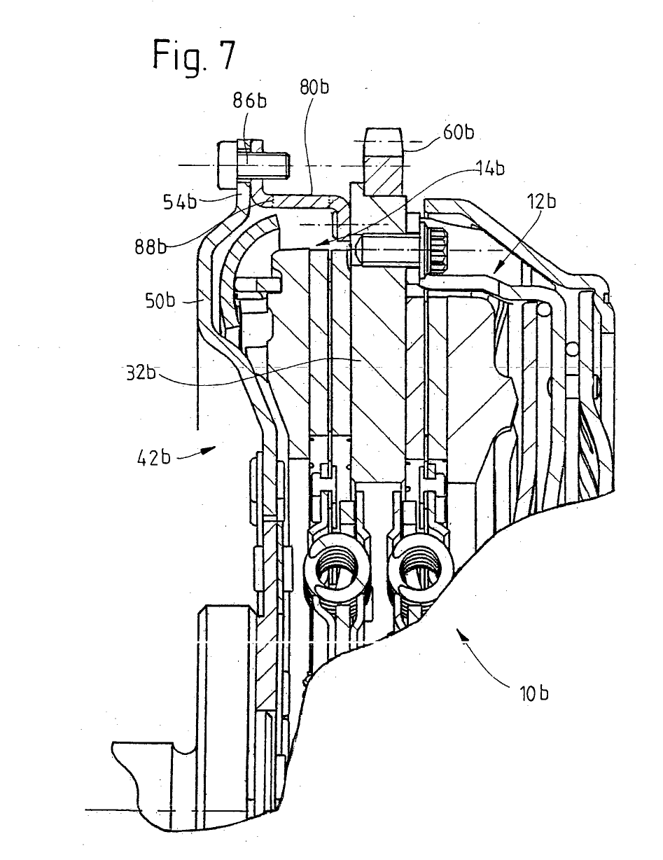

FIG. 7 shows a modification of the embodiment shown in FIG. 6. Here again, the connecting assembly 42b comprises an intermediate connecting ring 80b, which is attached to the intermediate plate 32b by rivets or screws, for example, on one side and to the essentially radially oriented first connecting section 54b of the connecting plate part 50b on the other side by screw bolts 86b or by rivets, or the like. The gear ring 60b can be provided here as a separate component, which can be shrunk-fit, for example, onto the outside circumferential area of the intermediate plate 32b. To improve the ventilation of the double clutch assembly according to FIG. 7, several pass-through openings or recesses 88b, indicated schematically in the figure, can be provided in the intermediate ring element 80b.

The intermediate ring element 80b shown in FIG. 7 can be easily and inexpensively provided as a formed metal plate.

It should be pointed out that, in the case of the embodiments shown in FIGS. 6 and 7 above, reference was made to an “intermediate connecting ring 80b”. This may include a plurality of individual segments which together form a ring, each of which is permanently attached individually to the intermediate plate 32b on one side and to the connecting plate part 50b on the other, but which otherwise do not need to be permanently connected to each other and which possibly can be arranged with a slight circumferential gap between them. The important point here is that this type of formation consisting of several intermediate connecting elements works together to form a ring-like configuration extending around the circumference of the double clutch assembly 10b. This formation could, for example, be formed by three ring segments 120° apart (relative, for example, to their circumferential center areas) or, for example, by four segments 90° apart (again relative to their circumferential center areas).

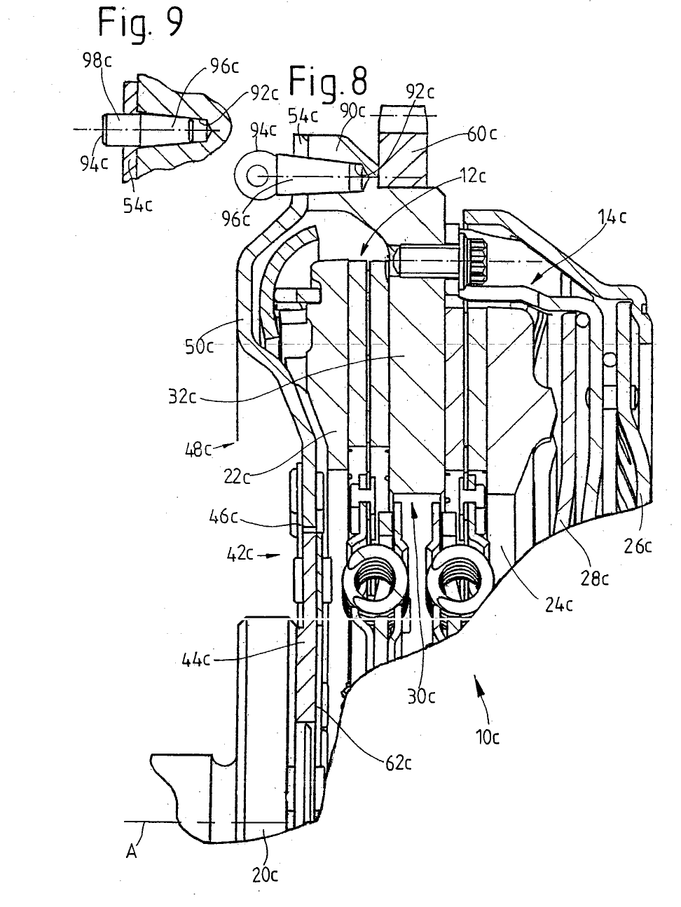

Another double clutch assembly designed in accordance with the invention is shown in FIG. 8. Components which correspond to those described above with respect to design or function are designated by the same reference numbers plus a “c”.

In the embodiment shown in FIG. 8, an axial shoulder 90c, which is completely continuous in the circumferential direction or which possibly can be designed as a series of segments, is formed in the radially outer area of the intermediate plate 32c. The first connecting section 54c of the connecting plate assembly 48c rests axially against this shoulder. The connecting section 54c is formed in turn as an essentially radially oriented end of a connecting plate part 50c. Distributed over its circumference, the shoulder 90c has several attachment holes 92c, which taper down toward the bottom. These holes can have a rotationally symmetric, i.e., conical frustum-like configuration, but in principle they can also have surfaces which slant toward each other in a wedge-like manner. Connecting elements 94c with correspondingly tapered fastening sections 96c are inserted into the fastening holes 92c, and they are inserted with a force sufficient to hold them in place in a friction-locking manner. The tapering fastening sections 96c also pass through the holes formed in the first connecting section 54c, so that the outward-expanding configuration of the fastening sections 96c also provides simultaneously for the axial fixation of the connecting plate part 50c to the intermediate plate 32c in the area of the first connecting section 54c.

So that, upon assembly, the holes provided in the first connecting section 54c can be kept properly aligned with the fastening holes 92c, centering pins can be provided, which specify a certain relative rotational position of the connecting plate assembly 48c with respect to the intermediate plate 32c.

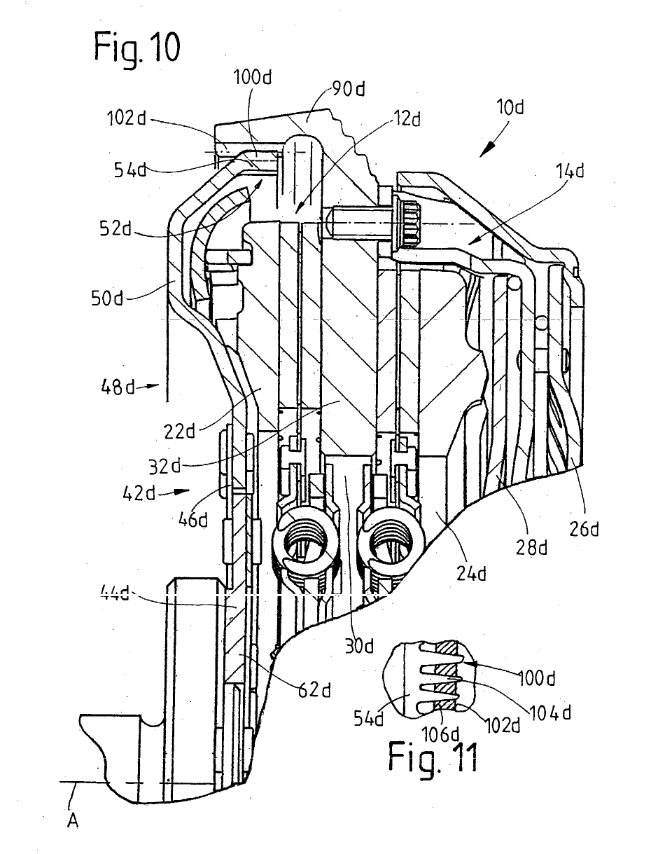

FIG. 9 shows an embodiment in which only the fastening section 96c of the connecting elements 94c, that is, only the section which is inserted into in the holes 92c, has a tapered design. The section 98c passing through the hole in the first connecting section 54c is designed with a cylindrical outside circumference, so that the free, outward-pointing ends of the connecting elements 94c do not have an expanding circumference. In this embodiment, the connecting elements 96c, can be attached to the intermediate plate 32c before the intermediate plate 32c is attached to the connecting plate assembly 48c; then, as the connecting plate assembly 48c is brought up into position, the connecting elements can be inserted into their assigned holes, so that the connecting elements 94c also serve a centering function simultaneously. Whereas, in the embodiment according to FIG. 8, the connecting elements 94c have an eyelet-like extension at their free outside ends to facilitate their removal, in the embodiment according to FIG. 9 the intermediate plate 32c can be separated from the connecting plate assembly 48c easily by pulling it away in the axial direction.

Another embodiment of a double clutch assembly according to the invention is shown in FIG. 10. Components which correspond to those described previously with respect to design or function are designated by the same reference numbers plus a “d”.

In the embodiment shown in FIG. 10, the more-or-less axially oriented, radially outer area 52d is again provided on the outer connecting plate part 50d; this outer area is designed to provide the first connecting section 54d, which now has a set of external spur gear teeth 100d. The set of external spur gear teeth 100d can be formed during the same process by which, for example, the outer connecting plate part 50d is shaped out of a metal plate. The intermediate plate 32d again has an axial shoulder 90d, which now has a set of internal spur gear teeth 102d on an inner circumferential surface. Using an axial insertion movement, the two sets of teeth 100d, 102d can be brought into engagement with each other, so that a torsion-proof connection between the intermediate plate 32d and the connecting plate assembly 48d can be achieved without the need for any additional connecting elements, or the like. Of course, it is also possible for the connecting plate part 50d to be provided with a set of internal spur gear teeth and for the intermediate plate 32d to be provided with a set of external spur gear teeth instead, such as in the area of the axial shoulder 90d.

To ensure that the two sets of teeth 100d, 102d have the least possible amount of play with respect to each other, which is important for the purpose of avoiding impact or chattering noises and corresponding wear in the area of the teeth 100d, 102 in the presence of rotational irregularities, it is advantageous for the two sets of teeth to rest against each other under pretension. In the embodiment shown in FIG. 10, this can be accomplished by providing the two sets of teeth 100d, 102d with an appropriate design and the appropriate dimensions.

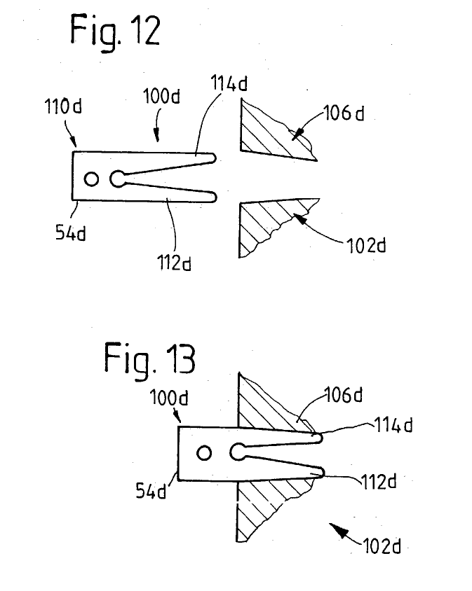

FIG. 11 shows a further embodiment, in which each individual tooth 104d of the set of teeth 100d provided on the connecting plate part 50d in the area of the first connecting section 54d tapers down conically in an approximately axial direction toward its free end. The set of teeth 102d on the intermediate plate 32d then consists of individual teeth 106d which, for example, are oriented in an approximately radial direction, and which are designed so that the gaps between them taper in a manner which corresponds to the tapering shape of the teeth 104d. A small amount of axial pretension can therefore ensure that the two sets of teeth 100d, 102d will engage with each other without play.

When the sets of teeth 100d, 102d are both designed as spur gear teeth, as shown in FIG. 10, a play-free engagement can be also be achieved by providing the teeth and the gaps into which they fit with appropriately tapering designs.

When the intermediate plate 32d and the connecting plate part 50d are to be assembled, it is a particular advantage of the embodiment shown in FIGS. 10 and 11 that, as a result of the small pitch of the teeth, even a slight relative rotation of the two components is sufficient to bring the sets of teeth 100d, 102d into a relative position which allows them to engage with each other.

FIGS. 12 and 13 show another embodiment, by means of which the two meshing sets of teeth 100d, 102d can be prevented from generating chattering noises. The spring element 110d in FIG. 12 can be a separate component which is attached by riveting, screwing, or pinning, or by welding, brazing, or bonding with an adhesive to the connecting section 54d, namely, to at least one area on the circumference of that section where normally one of the teeth 104d in FIG. 11 would be provided. This spring element 110d, however, can also obviously be made as an integral part of the connecting section 54d. The spring element 110d has two sidepieces 112d, 114d, which, because of the elasticity of the material of the spring element 110d, such as metal sheet or plate material or plastic material, can be bent toward each other. When the two sets of teeth 100d, 102d are brought into engagement with each other, this spring element 110d or possibly several such spring elements 110d enter the gaps between the individual teeth 106d, which, as can also be seen in FIG. 12, have a taper in the insertion direction. The spring sidepieces 112d, 114d are thus bent toward each other, so that the spring element is held under pretension in the gap between two teeth 106d. In this way, it is possible to prevent the two components from being connected to each other from moving relative to each other and thus causing chattering noises. At the same time, it remains possible to separate them from each other easily in the axial direction.

It is also possible, of course, to provide similar spring elements in place of the teeth 106d; these spring elements would then be pushed into the tapering gaps between pairs of teeth 104d. For the purpose of preventing undesirable circumferential movements or chattering noises, it is also possible to insert helical compression springs or other spring elements in the gaps between two teeth, these springs being supported on the other set of teeth. In this case, some of the teeth designed in this way to prevent chattering noises must be made with narrower dimensions to provide the necessary space for the springs.

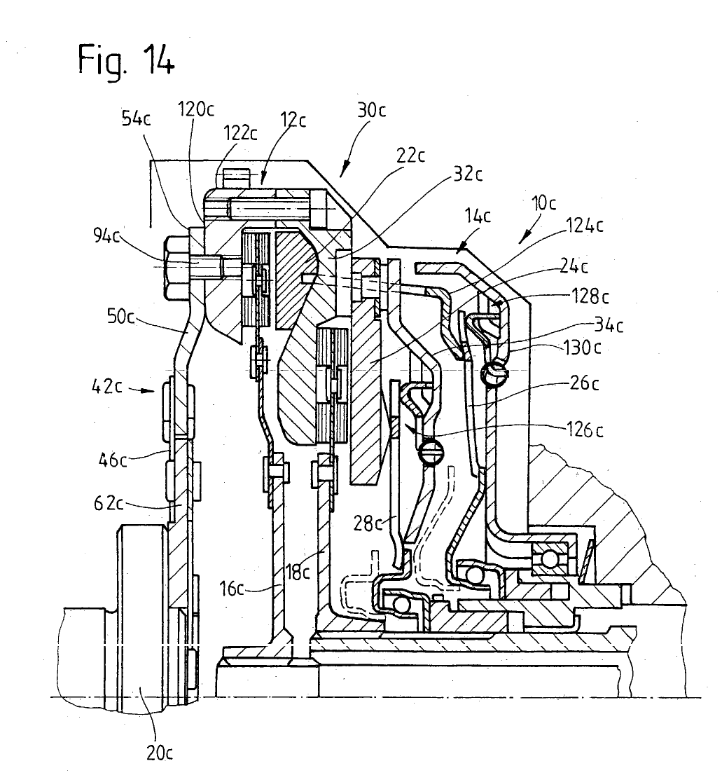

FIG. 14 shows another embodiment of a connection of a double clutch 10c to a drive shaft 20c using a connecting assembly 42c, such as that described and explained above. Here, too, the connecting assembly 42c comprises the two connecting plate parts 50c and 62c, which are connected to each other by the leaf spring elements 46c. The connection of the connecting plate part 50c by its more-or-less radially oriented connecting section 54c is accomplished in a manner similar to that used for the variant shown in FIG. 8. Here, too, more-or-less axially oriented connecting elements 94c are provided, which pass through holes in the connecting section 54c and are inserted into the abutment assembly, designated 30c overall, in the area of an axial end surface 120c of that assembly. In particular, screw bolts are provided here as fastening elements 94c, which are inserted into corresponding internally threaded holes in the abutment assembly 30c.

It can be seen here, however, that the intermediate plate 32c serves only as an abutment area for the clutch disk 18c, i.e., for the pressure plate 24c assigned to it. For the clutch area 12c, an additional ring-like plate part 122c is provided, which is connected in its radially outer area to the intermediate plate 32c by screw bolts, for example. In the radially outer area of the intermediate plate 32c, furthermore, there is a recess, into which the pressure plate 22c of the clutch area 12c essentially fits. The actuating force exerted by the actuating system on the force-exerting assembly 26c for the clutch area 12c is transmitted via a force-transmitting element 124c part of which passes through the housing 34c and the intermediate plate 32c on its way to the pressure plate 22c, which thus can be moved in the same direction as the pressure plate 24c of the clutch area 14c to produce the engaged state. The intermediate plate 32c and the plate part 122c thus form essentially together the abutment assembly 30c, which absorbs the actuating forces exerted on the pressure plates 22c, 24c when the clutch is being engaged and the clutch disks 16c, 18c are being clamped between their pressure plates and the abutment. In this example, the connecting assembly 42c is connected to the area of the plate part 122c.

It should also be pointed out that, in the exemplary embodiment, wear take-up devices 126c, 128c are provided, one being assigned to each of the two clutch areas 12c, 14c. One of these wear take-up devices acts between the housing assembly 34c of the clutch area 14c and the associated force-exerting assembly 28c, and the other acts between a corresponding housing assembly 130c of the clutch area 12c and the force-exerting assembly 26c, so that, when wear occurs, it is ensured that the force-actuating assemblies remain in more-or-less the same installation position.

It can be seen in FIG. 14 that the various previously described principles by which the abutment assembly of a double clutch is connected to a drive shaft by a connecting assembly can be realized regardless of the internal design of the clutch assembly or even of the design of the abutment assembly. That is, it is also possible to realize all of the previously described connection embodiments in the double clutch shown in FIG. 14.

Various embodiments of a double clutch assembly and of a connecting assembly for these clutch assemblies have been described above which make it possible to connect the double clutch assembly easily to a drive shaft or the like. At the same time, all of the embodiments provide a very reliable connection and in particular a connection which is isolated with respect to wobbling movements because of the elasticity present in the area of the connecting assembly.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Thus, while there have shown and described and pointed out fundamental novel features of the invention as applied to a preferred embodiment thereof, it will be understood that various omissions and substitutions and changes in the form and details of the devices illustrated, and in their operation, maybe made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A double clutch assembly comprising:
an abutment assembly having an outer circumferential surface;
a first clutch assembly comprising a first pressure plate;
a first force exerting assembly which can move said first pressure plate toward said abutment assembly;
a second clutch assembly comprising a second pressure plate;
a second force exerting assembly which can move said second pressure plate toward said abutment assembly;
a connecting plate assembly for connecting the abutment assembly to a drive element, said connecting plate assembly having a radially outer first connecting section extending over said outer circumferential surface; and
a plurality of connecting elements connecting said first connecting section to said outer circumferential surface.

2. A double clutch assembly as in claim 1 wherein said connecting assembly comprises an integrally formed starter ring gear, said first connecting section extending axially from said ring gear.

3. A double clutch assembly as in claim 1 wherein said connecting plate assembly comprises:
a radially outer part having said first connecting section;
a radially inner part having a second connecting section which can be connected to said drive element; and
an elastic connecting assembly connecting said radially inner part to said radially outer part to permit relative rotational movement.

4. A double clutch assembly comprising:
an abutment assembly;
a first clutch assembly comprising a first pressure plate;
a first force exerting assembly which can move said first pressure plate toward said abutment assembly;
a second clutch assembly comprising a second pressure plate;
a second force exerting assembly which can move said second pressure plate toward said abutment assembly;
a connecting plate assembly for connecting the abutment assembly to a drive element, said connecting plate assembly comprising a radially outer first connecting section which extends axially;
an axial projection formation on said abutment assembly, at least part of said axial projection section axially overlapping said first connecting section of said connecting plate assembly; and
a plurality of connecting elements fixing said first connecting section to said axial projecting section for rotation in common.

5. A double clutch assembly as in claim 4 wherein said axial projection formation lies radially outside of said first connecting section.

6. A double clutch assembly as in claim 4 wherein said connecting plate assembly comprises:
a radially outer part having said first connecting section;
a radially inner part having a second connecting section which can be connected to said drive element; and
an elastic connecting assembly connecting said radially inner part to said radially outer part to permit relative rotational movement.

7. A double clutch assembly comprising:
an abutment assembly having a radially outer area;
a first clutch assembly comprising a first pressure plate;
first force exerting assembly which can move said first pressure plate toward said abutment assembly;
a second clutch assembly comprising a second pressure plate;
a second force exerting assembly which can move said second pressure plate toward said abutment assembly;
a connecting assembly for connecting the abutment assembly to a drive element, said connecting assembly comprising an intermediate connecting ring and a connecting plate assembly having a radially outer first connecting section;
a plurality of first connecting elements fastening said intermediate connecting ring to said radially outer area of said abutment assembly; and
a plurality of second connecting elements fastening said first connecting section to said intermediate connecting ring.

8. A double clutch assembly as in claim 7 further comprising a starter ring gear formed on said intermediate connecting ring.

9. A double clutch assembly as in claim 7 wherein at least some of said first connecting elements and at least some of said second connecting elements are threaded bolts, said intermediate connecting element comprising threaded holes, each of said threaded holes receiving both a first connecting element and a second connecting element.

10. A double clutch assembly as in claim 9 wherein said intermediate connecting ring is a formed metal plate.

11. A double clutch assembly as in claim 7 wherein said first connecting section extends essentially radially.

12. A double clutch assembly as in claim 7 wherein said connecting plate assembly comprises:
a radially outer part having said first connecting section;
a radially inner part having a second connecting section which can be connected to said drive element; and
an elastic connecting assembly connecting said radially inner part to said radially outer part to permit relative rotational movement.

13. A double clutch assembly comprising:
an abutment assembly having a radially outer area;
a first clutch assembly comprising a first pressure plate;
a first force exerting assembly which can move said first pressure plate toward said abutment assembly;
a second clutch assembly comprising a second pressure plate;
a second force exerting assembly which can move said second pressure plate toward said abutment assembly;
a connecting plate assembly for connecting the abutment assembly to a drive element, said connecting plate assembly having a radially outer first connecting section extending essentially radially; and
a plurality of connecting elements fastening said first connecting section to said radially outer area of said abutment assembly for rotation in common.

14. A double clutch assembly as in claim 13 wherein said abutment section has tapered fastening holes, at least some of said connecting elements having tapered fastening sections which are received in said tapered fastening holes in an interference fit.

15. A double clutch assembly as in claim 13 wherein at least some of said connecting elements have tapered fastening sections which pass through the first connecting section.

16. A double clutch assembly as in claim 13 wherein at least some of said connecting elements have cylindrical sections which pass through the first connecting section.

17. A double clutch assembly as in claim 13 wherein said connecting plate assembly comprises:
a radially outer part having said first connecting section;
a radially inner part having a second connecting section which can be connected to said drive element; and
an elastic connecting assembly connecting said radially inner part to said radially outer part to permit relative rotational movement.

18. A double clutch assembly comprising:
an abutment assembly having a set of teeth;
a first clutch assembly comprising a first pressure plate;
a first force exerting assembly which can move said first pressure plate toward said abutment assembly;
a second clutch assembly comprising a second pressure plate;
a second force exerting assembly which can move said second pressure plate toward said abutment assembly;
a connecting plate assembly for connecting the abutment assembly to a drive element, said connecting plate assembly having a radially outer first connecting section with a set of teeth which engage said teeth on said abutment assembly for rotation in common.

19. A double clutch assembly as in claim 18 wherein said teeth on said first connecting section engage said teeth on said abutment assembly under pretension.

20. A double clutch assembly as in claim 18 wherein said teeth on said first connecting section have tapered ends which engage in correspondingly tapered gaps between said teeth on said abutment assembly.

21. A double clutch assembly as in claim 18 wherein said connecting plate assembly comprises:
a radially outer part having said first connecting section;
a radially inner part having a second connecting section which can be connected to said drive element; and
an elastic connecting assembly connecting said radially inner part to said radially outer part to permit relative rotational movement.
